(19) United States
(12) Patent Application Publication
(10) Pub. No.: US 2012/0057914 A1
(43) Pub. Date: Mar. 8, 2012

(54) Resource expander keys

(76) Inventor: Suni Vili Perez, Ocala, FL (US)

(21) Appl. No.: 12/807,368

(22) Filed: Sep. 3, 2010

(51) Int. Cl. B41J 5/12

(52) U.S. Cl. 400/489

(57) ABSTRACT

This invention consists of 4 sliver (s-l-i-v-e-r) keys surrounding a square center key, which move downward to separate contacts. These narrow keys form a box around the center key with corners and sides which can be felt. Which of these sliver (s-l-i-v-e-r) keys the typist hits along with the center key, determines which of 9 letters, numbers or actions will result.

The following demonstrates how one Resource Expander Key on a computer keyboard or a cell phone can generate 9 pieces of text:
center key+top left corner (left sliver key+top sliver key)=a
center key+top side (top sliver key)=b
center key+top right corner (top sliver key+right sliver key)=c
center key+left side (left sliver key)=d
center key alone (middle)=e
center key+right side (right sliver key)=f
center key+bottom left corner (left+bottom sliver keys)=g
center key+bottom side (bottom sliver key)=h
center key+bottom right corner (bottom+right sliver keys)=i

Add 3 more of these composite keys and you have all letters of the alphabet from ‘a’ to ‘z’ and all digits from 0 to 9. Its application for texting on cell phones is obvious. On a computer keyboard, it can give all 10 fingers individual access to the entire alphabet, allowing one to spell-type up to 10-letter words with every press on the keyboard. Since the keys can be operated by feel, they can be used on remotes one can work from inside one's pocket. Hidden manipulation of remotes with these keys can have application to police work and the military.

### PREAMBLE

The RESOURCE EXPANDER KEY, invented by Suni V. Perez as far back as 2005 when she first applied for a Utility Patent, came from her efforts to increase what each finger can access on the current computer keyboard. This is her second effort to obtain a Utility Patent for her invention. A column of 3 of Suni's Resource Expander Keys (composite keys which each consist of 5 parts) will give the typist access to all 26 letters of the alphabet plus hyphen. For the first time, typists can use all their fingers to spell-type up to 10-letter words in one press on the keyboard.

Through the use of sliver (s-l-i-v-e-r) keys which are felt as sides and corners around a center key, Suni has provided a different way to increase what can be accomplished by one finger, which is not only user-friendly to the blind, but to people with large fingers, who have trouble with today's miniaturized keypads and keyboards.

Suni's Resource Expander Key can have many other applications besides word processing, among which are remote controls and cell phones. Because her keys can be operated totally by feel, they can be used by the blind and also in police work and in the military. Imagine being able to put a hand in your pocket and accomplish 9 actions just by feeling with one finger the corners and sides around the center of one of Suni's composite keys. Make that a column of 3 Resource Expander Keys and you can accomplish with one finger 27 actions all from inside your pocket.

### PREVIOUS PATENT EFFORTS

Suni started in June of 2005 with Application 60-697444 and continued in November of 2005 with application Ser. No. 11/262,165, until her examiner informed her in June of 2009 that multiple contacts under single keys in other Utility Patents somehow undermine her sliver (s-l-i-v-e-r) keys too narrow to be hit alone, even though not one of those patents had composite keys consisting of a center key with sliver (s-l-i-v-e-r) keys around it, nor could any of them produce 9 letters or actions!

Keys and keyboards mistakenly put forth as conflicts included U.S. Pat. No. 5,861,588, U.S. Pat. No. 4,972,762, U.S. Pat. No. 5,861,821 and GB 2263183. Realizing her key design is indeed unique and finding the Patent Office insisted they could not continue her first Utility Patent effort without her hiring a Patent Attorney, Suni was forced to abandon her first effort. She immediately applied for a Design Patent (29/316,318). The first office action in July of 2010 informed her few comments involving use or function can be made in Design Patents. Hence this renewed effort for a Utility Patent.

### BACKGROUND OF THE INVENTION

Suni comes from a family of teachers. Her father taught Spanish, French and other languages at college level and in adult education for over 40 years. She attended the Stenotype Academy in Brooklyn from 1965 to 1967, and worked hard to standardize Stenotype, which led to the following copyrights:
TXU 15-582 (Nov. 4, 1978) “THE SUNI COMPUTER STENOTYPE SYSTEM DICTIONARIES”
TXU 15-139-755 (Oct. 24, 1983) “THE ABRIDGED SUM STENOTYPE SYSTEM”
TXU 157-107 (Apr. 9, 1984) “SUM WORD PROCESSOR STENO”
TXU 175-536 (Jul. 13, 1984) “SUNISTENO 1: The Student, Secretary, Writer, Suni Word Processor Steno, Self-Study Manual”
TXU 237-268 (Apr. 22, 1986) “SUNITYPE FOR EVERYONE: A Self-Study Manual”
TXU 249-121 (Aug. 8, 1986) “same title”: Edition 2, A Self-Study Manual”

This effort led Suni to reject the Stenotype Keyboard as a low-capacity keyboard, which thwarted standardization by generating too much to learn. She set to work to design a high-capacity keyboard. Efforts based on her Resource Expander Key, led her to create 9 teaching manuals, each a greater departure from Stenotype, until nothing from Stenotype remains except the ability to press down with 2 to 10 fingers at once.
TXU 1-238-358 (Apr. 8, 2005), TXU 1-286-177 (Mar. 7, 2006),
TXU 1-335-102 (Oct. 27, 2006), TXU 1-321-448 (Oct. 20, 2006)
TXU 1-362-826 (Oct. 31, 2006), TXU 1-328-168 (Nov. 27, 2006)
TXU 1-338-084 (Dec. 29, 2006), TXU 1-636-000 (Oct. 23, 2009)

The Ninth Version of Suni's COMPUTER SPEED TYPE COURSE MANUAL, the simplest and most versatile which covers French as well as English and Spanish, was sent to the Copyright Office on Aug. 10, 2010.

### SUMMARY OF INVENTION

See the Abstract which shows how one Resource Expander Key works to produce 9 results. When the typist looks at a Resource Expander Key on a computer keyboard or a cell phone, he will learn to envision it as 3 rows of text. Thus for the example given in the Abstract, he will see the following in his mind:

| | | |
|---|---|---|
| a | b | c |
| d | e | f |
| g | h | i |

The next demonstration shows what can be accomplished by one Resource Expander Key on a remote for a 2-door car:
center key+top left corner (left sliver key+top sliver key)=open/close left window
center key+top side (top sliver key)=open/close hood
center key+top right corner (top sliver key+right sliver key)=open/close right window
center key+left side (left sliver key)=open/close left door
center key alone (middle)=power on/off
center key+right side (right sliver key)=open/close right door
center key+bottom left corner (left sliver key+bottom sliver key)=on/off car lights
center key+bottom side (bottom sliver key)=open/close trunk
center key+bottom right corner (bottom sliver key+right sliver key)=on/off AC

Envision this in 3 rows as you did the text, and you will see how well it works spatially:

| | | |
|---|---|---|
| left window | hood | right window |
| left door | on/off | right door |
| lights | trunk | AC |

The vague resemblance which Suni's unique, composite keys have to single keys, explains why the following patents have been mistakenly listed as conflicts: US-D302,977, U.S. Pat. No. 305,422, US-D335,660, US-D411,528, US-D485,271, US-D543,544, US-D219,027, U.S. Pat. No. 4,917,516, U.S. Pat. No. 5,186,555, U.S. Pat. No. 5,528,235, U.S. Pat. No. 5,717,430, U.S. Pat. No. 5,794,762, U.S. Pat. No. 5,841,374, U.S. Pat. No. 6,053,647, U.S. Pat. No. 6,377,685, U.S. Pat. No. 6,657. Not one of these patents feature a center key with sliver (s-l-i-v-e-r) keys around it, which each move downward to different contacts.

Miniaturization on boards of Resource Expander Keys can be managed by removing the space between these composite keys. This can make the sliver (s-l-i-v-e-r) keys so close, they will need to be combined into single keys. From this point on, I will refer to 2 sliver (s-l-i-v-e-r) keys combined into slightly wider keys as ‘melded keys’.

Keyboards and keypads with melded Resource Expander Keys, meaning fewer keys and contacts, will have the capacity of those with separate Resource Expander keys, so long as one finger is used or only one finger at a time. If 2 to 10 fingers are used at once, no sliver keys between fingers can be melded or options would be lost.

What follows is a summary of how a column of 3 Resource Expander Keys, with or without melded keys between them, can give the entire alphabet to one finger:
center top key+top left corner (left sliver key+top sliver key)=a
center top key+top side (top sliver key)=b
center top key+top right corner (top sliver key+right sliver key)=c
center top key+left side (left sliver key)=d
center top key alone (middle)=e
center top key+right side (right sliver key)=f
center top key+bottom left corner (left sliver key+bottom sliver or melded key)=g
center top key+bottom side (bottom sliver or melded key)=h
center top key+bottom right corner (bottom sliver or melded key+right sliver key)=i
center middle key+top left corner (left sliver key+top sliver or melded key)=j

center middle key+top side (top sliver or melded key)=k
center middle key+top right corner (top sliver or melded key+right sliver key)=l
center middle key+left side (left sliver key)=m
center middle key alone (middle)=n
center middle key+right side (right sliver key)=o
center middle key+bottom left corner (left sliver key+bottom sliver or melded key)=p
center middle key+bottom side (bottom sliver or melded key)=q
center middle key+bottom right corner (bottom sliver or melded key+right sliver key)=r
center bottom key+top left corner (left sliver key+top sliver or melded key)=s
center bottom key+top side (top sliver or melded key)=t
center bottom key+top right corner (top sliver or melded key+right sliver key)=u
center bottom key+left side (left sliver key)=v
center bottom key alone (middle)=w
center bottom key+right side (right sliver key)=x
center bottom key+bottom left corner (left sliver key+bottom sliver key)=y
center bottom key+bottom side (bottom sliver key)=z
center bottom key+bottom right corner (bottom sliver key+right sliver key)=−

A combination of 4 Resource Expander Keys in a square pattern (two rows, two columns) with or without melded keys between them, would give to one finger the entire alphabet plus 10 digits, great for texting on cell phones.
center top left key+top left corner (left sliver key+top sliver key)=0
center top left key+top side (top sliver key)=1
center top left key+top right corner (top sliver key+right sliver or melded key)=2
center top right key+top left corner (left sliver or melded key+top sliver key)=3
center top right key+top side (top sliver key)=4
center top right key+top right corner (top sliver key+right sliver key)=5
center top left key+left side (left sliver key)=6
center top left key alone (middle)=7
center top left key+right side (right sliver key or melded key)=8
center top right key+left side (left sliver key or melded key)=9
center top right key alone (middle)=a
center top right key+right side (right sliver key)=b
center top left key+bottom left corner (left sliver key+bottom sliver or melded key)=c
center top left key+bottom side (bottom sliver or melded key)=d
center top left key+bottom right corner (bottom sliver or melded key+right sliver or melded key)=e
center top right key+bottom left corner (left sliver or melded key+bottom sliver or melded key)=f
center top right key+bottom side (bottom sliver or melded key)=g
center top right key+bottom right corner (bottom sliver or melded key+right sliver key)=h
center bottom left key+top left corner (left sliver key+top sliver or melded key)=i
center bottom left key+top side (top sliver or melded key)=j
center bottom left key+top right corner (top sliver or melded key+right sliver or melded key)=k
center bottom right key+top left corner (left sliver or melded key+top sliver or melded key)=l
center bottom right key+top side (top sliver or melded key)=m
center bottom right key+top right corner (top sliver or melded key+right sliver key)=n
center bottom left key+left side (left sliver key)=o
center bottom left key alone (middle)=p
center bottom left key+right side (right sliver or melded key)=q
center bottom right key+left side (left sliver or melded key)=r
center bottom right key alone (middle)=s
center bottom right key+right side (right sliver key)=t
center bottom left key+bottom left corner (left sliver key+bottom sliver key)=u
center bottom left key+bottom side (bottom sliver key)=v
center bottom left key+bottom right corner (bottom sliver key+right sliver or melded key)=w
center bottom right key+bottom left corner (left sliver or melded key+bottom sliver key)=x
center bottom right key+bottom side (bottom sliver key)=y
center bottom right key+bottom right corner (bottom sliver key+right sliver key)=z

Another option on keyboards making use of melded keys, would to use these wider keys in place of all sliver (s-l-i-v-e-r) keys to have a more uniform design. However, in keyboards designed for 2 to 10 fingers to press down simultaneously, the number of keys and contacts between fingers must be maintained to preserve 9 options for each and every Resource Expander Key.

Due to the ability of a keyboard with 30 Resource Expander Keys (3 operated per finger) to give access to each and every finger to the entire alphabet, enabling the typist to spell up to 10-letter words in a single press, my drawings end with a sample which compares productivity when my new keyboard is used as a conventional keyboard versus a Speed Type Keyboard. With Speed Type, there should be a 600 percent improvement in productivity, all from a small translation program, since unlike Voice Recognition it doesn't need to be adapted to each and every individual who uses the system.

Imagine typing whole words or pairs of short words with one press and seeing them pop up on your computer screen, filling the entire screen in a few seconds.

### DESCRIPTION OF DRAWINGS

FIG. 1 shows my Resource Expander Key from an angle. This is to overcome past Examiners tendencies to confuse it with single tapered keys when I have drawn it from the top alone. The separate parts of this composite key are labeled with Roman numerals. The center key is labeled ‘I’ and the surrounding sliver (s-l-i-v-e-r) keys are labeled ‘II, III, IV and V. Sliver key III is the top border key and sliver key V the bottom border key.

FIG. 2 shows the contacts below the keys. As you can see, each of the 5 keys in my Resource Expander key presses down onto a separate, distinct contact.

FIG. 3 has been included to make the structure of this unique composite key clear. The arrows on FIG. 3 indicate where the sliver (s-l-i-v-e-r) keys belong, not the direction which they move, which is straight down.

FIG. 4 shows how the typist would envision the 9 pieces of text he can produce with one of these composite keys. Here it is oriented to match FIGS. 1 and 2.

FIG. 5 shows how the owner of a 2-door car remote might envision the 9 actions he can initiate with one of these composite keys totally by feel, without ever needing to take the device out of his pocket.

FIG. 6 shows a computer keyboard of 30 Resource Expander Keys, able to spell English, Spanish and French words using 2 to 10 fingers at once. (See my Computer Speed Type Course Manual, Ninth Version, for how to capitalize, do numbers, punctuation, signs used in Spanish and French, etc.) The numbers above columns indicate which fingers from left to right operate them. The left thumb, which operates the keys below Number 5 also works the last key in Column 4. The right thumb, which operates the keys below Number 6, also works the last key in Column 7

FIG. 7 shows an ergonomic version of my keyboard. The keys are placed to make them more comfortable for short pinkies and for the thumbs. Otherwise, this keyboard functions like that shown in FIG. 6. Remember, though seen from the top, these are not single, tapered keys. They are composite keys with 5 separate parts. If the center keys are pressed alone, the four sliver (s-l-i-v-e-r) keys around them remain up, not going to their separate contacts. Only center keys, colored a light gray, can be pressed alone.

FIG. 8 shows 3 adjacent Resource Expander Keys, with the 4 sliver (s-l-i-v-e-r) keys between them melded into two.

FIG. 9 shows the contacts under these keys and that those of the melded sliver (s-l-i-v-e-r) keys are also melded.

FIG. 10 shows how 3 Resource Expander Keys give each finger all 26 letters of the alphabet and hyphen.

FIG. 11 gives you a closer look at the melded keys, equal in thickness to 2 sliver keys.

FIG. 12 shows 4 adjacent Resource Expander keys for use by one finger, which have 8 sliver (s-l-i-v-e-r) keys between them melded into 4.

FIG. 13 shows the contacts under these keys are also melded.

FIG. 14 shows how these 4 keys provide everything needed for texting on a cell phone, namely digits from ‘0’ to ‘9’ and letters from ‘a’ to ‘z’.

FIG. 15 shows the 4 melded keys separated from the others.

FIGS. 16 and 17 show melded versions of the keyboards shown in FIGS. 6 and 7. These keyboards can do everything the others can. Note that there is no melding of sliver (s-l-i-v-e-r) keys between keys operated by different fingers. This is necessary to retain 9 options for each and every Resource Expander key, and 27 options for every column of 3 of these composite keys. With any melding between fingers, the keyboard could no longer be used to spell type whole words up to 10 letters in a single press.

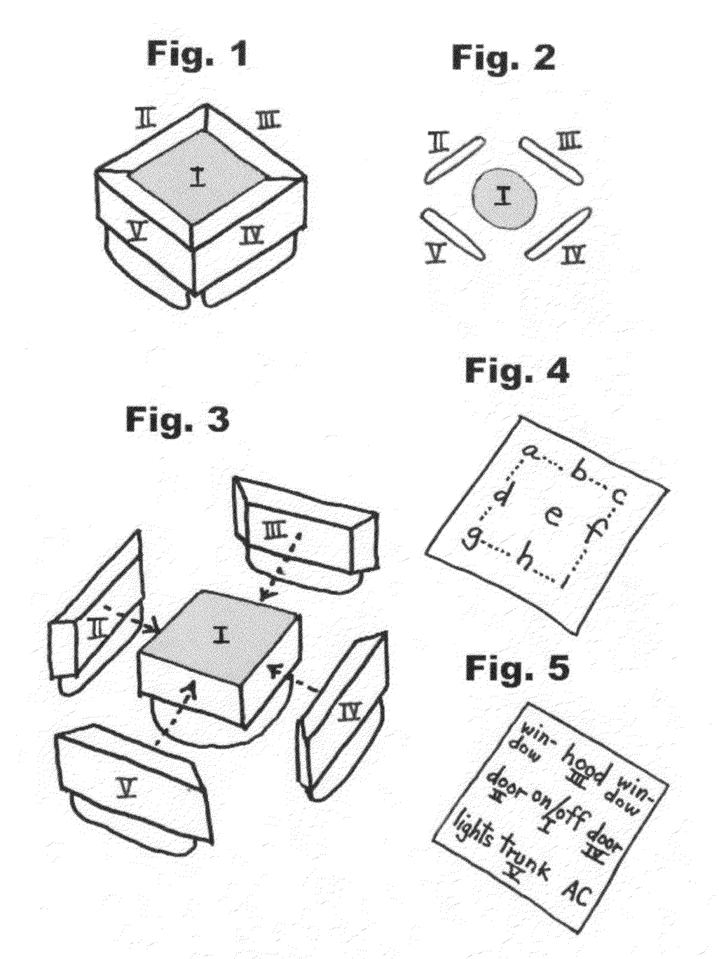

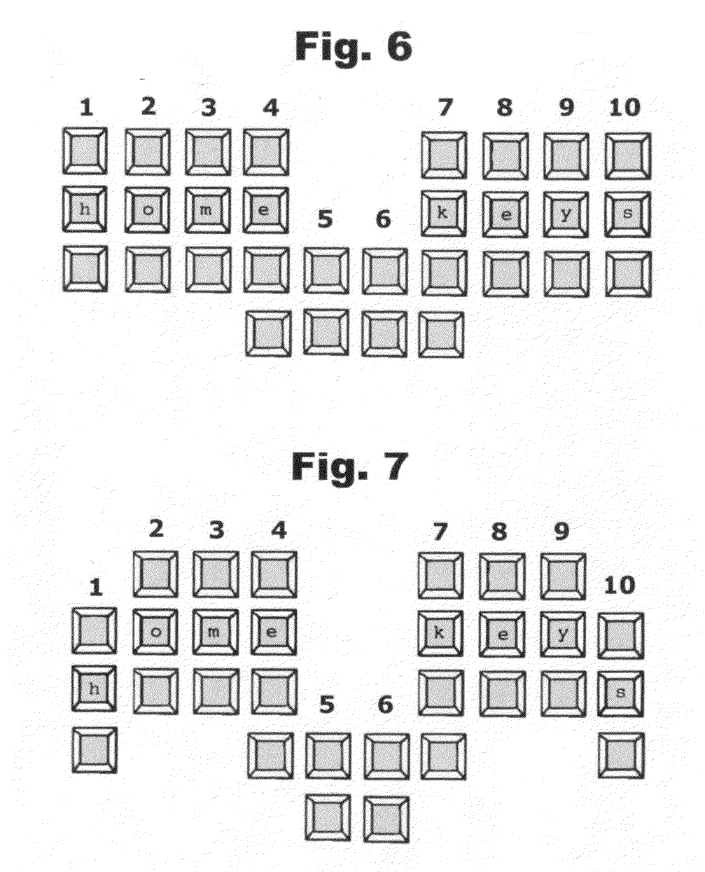

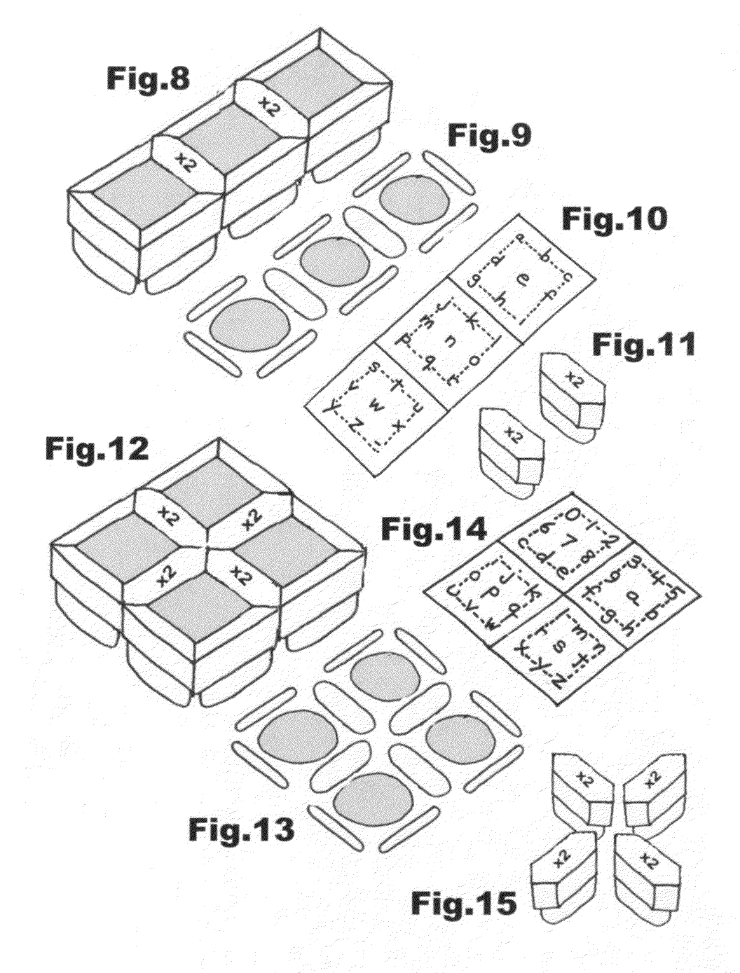

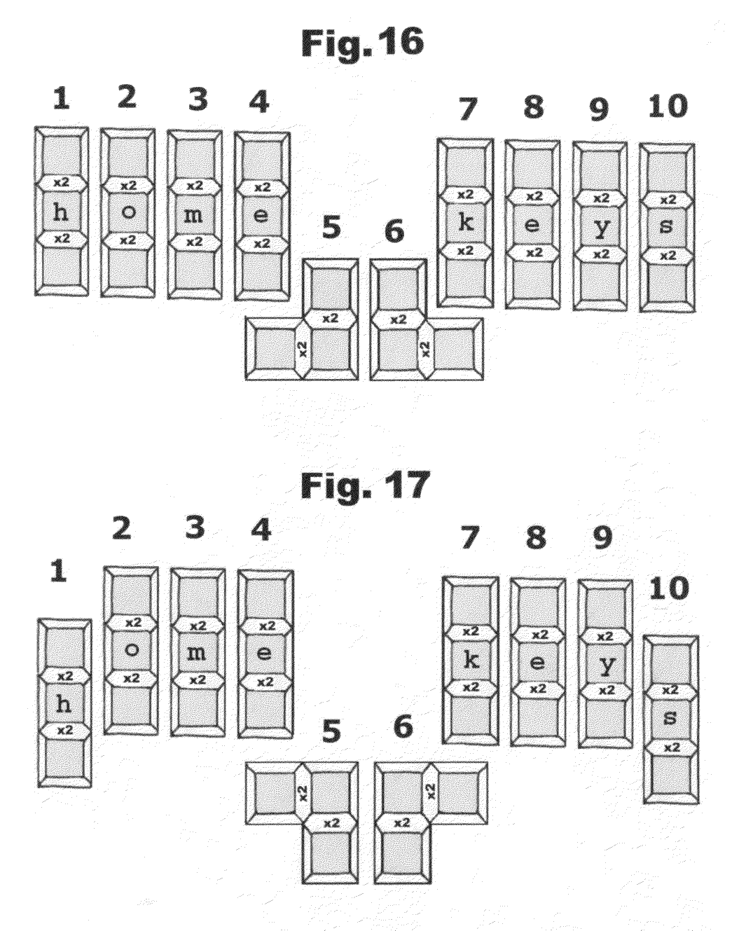

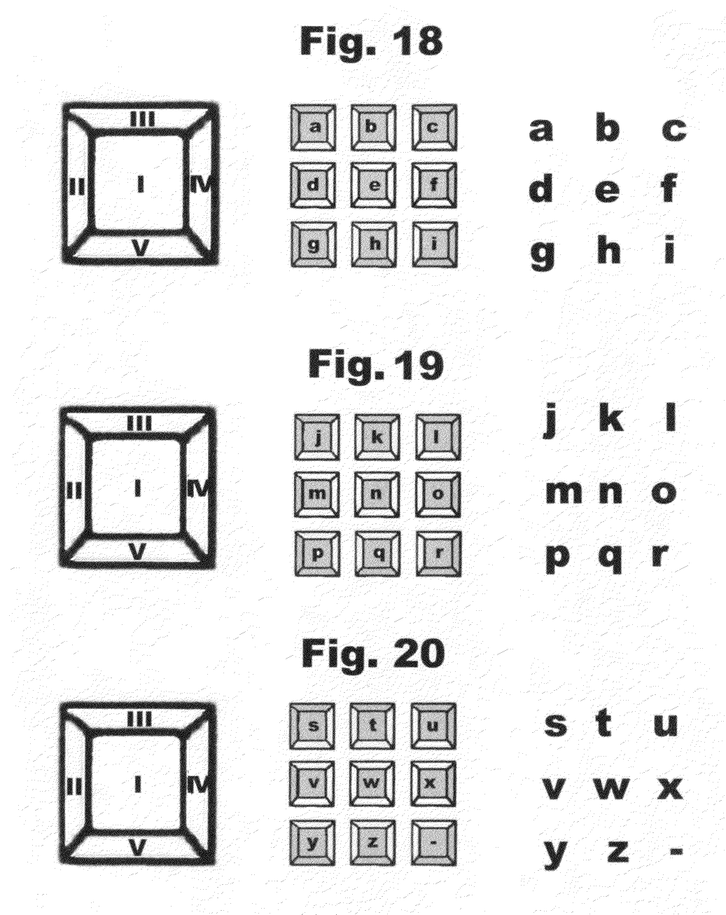

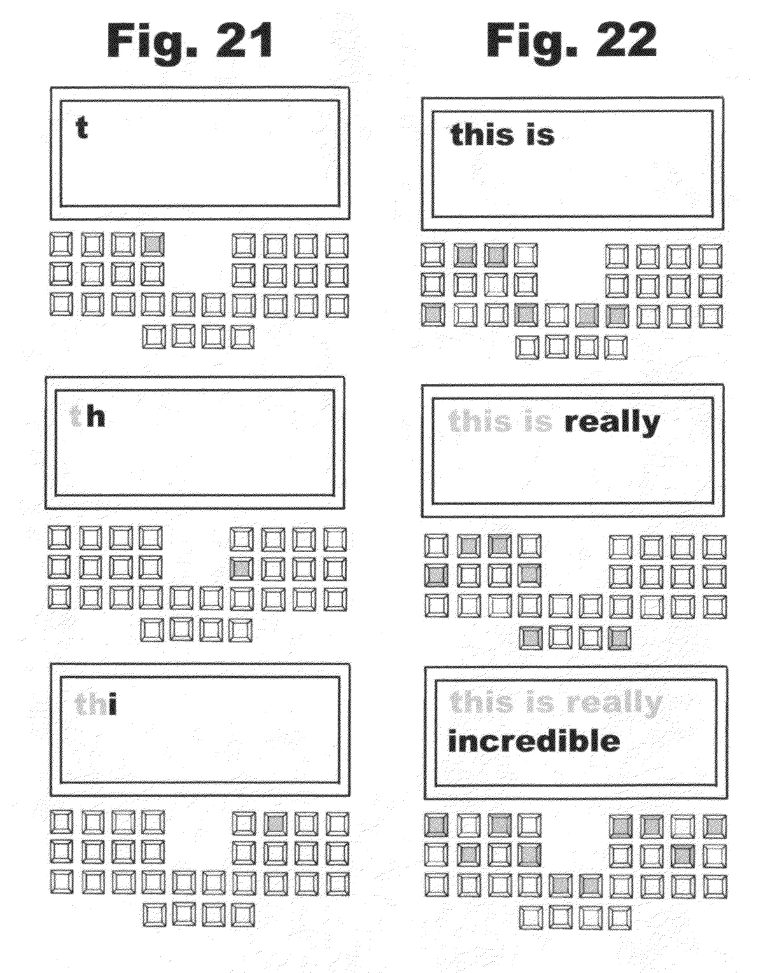

The purpose of FIGS. 18, 19 and 20 is to show which sliver keys pressed with the main key are generating the entire alphabet in one column of 3 Resource Expander Keys. Note in the first column, the parts of 3 of these composite keys are labeled as in FIG. 1. In the second column, what is pressed down to get the letters is indicated in gray:

1) for ‘a, j, s’, press the center key with what feels like a left top corner.
2) for ‘b, k, t’, press the center key with what feels like a top side.
3) for ‘c, 1, u’, press the center key with what feels like a right top corner.
4) for ‘d, m, v’, press the center key with what feels like a left side.
5) for ‘e, n, w’, press the center keys alone.
6) for ‘f, o, x’, press the center key with what feels like a right side.
7) for ‘g, p, y’, press the center key with what feels like a left bottom corner.
8) for ‘It, q, z’, press the center key with what feels like a bottom side.
9) for ‘i, r, -’, press the center key with what feels like a right bottom corner.
In the third column, is how the typist envisions the 9 letters produced by these keys.

FIG. 21 shows this keyboard used for conventional type. Note that 1, h, i′ are spatially where they are today on a conventional keyboard. Three presses on the keyboard are covered, giving just ‘thi’ on the computer screen. Gray on keys indicates which keys are pressed. Gray on the screen indicates letters already typed.

FIG. 22 shows this keyboard used for Speed Type. Three presses produces: ‘this is really incredible’, which is a 600 percent improvement in productivity. Gray on keys indicates which keys are pressed by more than one finger to get the black words on the screen. Gray words on the screen indicates which words were already typed.

1. A Resource Expander Key, which consists of a square center key and 4 sliver (s-l-i-v-e-r) keys that surround it, each which descends to a separate contact, and can produce up to 9 pieces of text or actions, depending which surrounding sliver keys are pressed down with the center key.

2. Keys which function like those in claim 1, but which are so closely adjacent some or all of the sliver (s-l-i-v-e-r) keys between their center keys have been melded into single keys with single contacts.

3. Any keyboard of keypad which has keys like those described in claims 1 and 2.
